(19) United States
(12) Patent Application Publication
(10) Pub. No.: US 2010/0250607 A1
(43) Pub. Date: Sep. 30, 2010

(54) PERSONAL INFORMATION MANAGEMENT APPARATUS AND PERSONAL INFORMATION MANAGEMENT METHOD

(75) Inventors: Jonghyouk Noh, Daejeon (KR); Seunghyun Kim, Daejeon (KR); Soohyung Kim, Daejeon (KR); Daeseon Choi, Daejeon (KR); Sangrae Cho, Daejeon (KR); Youngseob Cho, Daejeon (KR); Seunghun Jin, Daejeon (KR); Kyoil Chung, Daejeon (KR)

Correspondence Address: LAHIVE & COCKFIELD, LLP;FLOOR 30, SUITE 3000, ONE POST OFFICE SQUARE, BOSTON, MA, 02109, US

(73) Assignee: ELECTRONICS AND TELECOMMUNICATIONS RESEARCH INSTITUTE, DAEJEON-CITY (KR)

(21) Appl. No.: 12/744,002

(22) PCT Filed: Aug. 27, 2008
(86) PCT No.: PCT/KR08/05028

§ 371 Date: May 20, 2010

(30) Foreign Application Priority Data
Nov. 20, 2007 (KR) 10-2007-0118444

(51) Int. Cl. G06F 17/30

(52) U.S. Cl. 707/783; 707/E17.005

(57) ABSTRACT

The present invention relates to an apparatus and method that prevents personal information, which is provided from a user to a website when the user joins the website, from being illegally used. The user uses a reliable website where the personal information can be reliably managed and then stores the personal information in the reliable website. When the user provides the personal information to join a website, the user does not provide actual personal information but provides link information that can be used to link with the reliable website where the personal information is stored. The user and the reliable website share secret information to control a link access authority for the personal information.

### TECHNICAL FIELD

The present invention relates to a personal information management apparatus and method, and more particularly, to a personal information management apparatus and method that is capable of safely managing personal information that a user provides when joining a website on the Internet.

This work was supported by the IT R&D program of MIC/IITA [2007-S-601-01, User Control Enhanced Digital Identity Wallet system].

### BACKGROUND ART

With the rapid spread of the Internet, many people are utilizing various services that are provided by various websites. In order to utilize these services, an individual user needs to follow a subscription procedure of registering personal information of the user. The user registers an ID and a password, and inputs personal identity information, such as a name, an address, a telephone number, a social security number, and an email address.

Since the user generally needs to determine an ID and input personal information whenever the user joins a new website, it is inconvenient to the user. If the user joins a new website, in some cases, an ID that the user is using may already exist in that website because it is being used by another person. For this reason, if the user joins a plurality of websites, the user has no choice but to have a plurality of IDs.

Since the user generally joins many websites, the user may easily forget which websites the user inputs personal information thereto and what kind of information the user inputs thereto. In general, each of the websites separately registers personal information. Accordingly, when personal information, such as an address, is changed, the user should visit all websites that the user already joins and change the address.

In particular, a large number of small websites on the Internet do not consider information protection and privacy protection as important things when managing information of customers. Some websites illegally sell information about the customers. That is, since each of the websites separately manages personal information provided by users, it causes the misuse of personal information.

For this reason, a technology for safely managing and circulating personal information of users has been suggested. As a representative example, there is an Internet identity management system. The Internet identity management system is developed to provide a convenient and safe environment to users who use the Internet. That is, the Internet identity management system provides an SSO (Single Sign On) service in which the users can freely use many websites on the Internet by performing a login process once. The Internet identity management system stores information of the user in a safe website, such that the information of the user can be maintained in a concurrently updated state and safely managed. The standards and technologies that are related to the Internet identity management system have been developed. For example, Oasis Group provides SAML (Security Assertion Markup Language), Liberty Alliance provides ID-FF (IDentity Federation Framework), ID-WSF (IDentity Web Service Framework), and ID-SIS, and IBM and Microsoft Corporation provide WS (Web Service)-Security. As the standard that is used to safely manage personal information of the users, W3C (WorldWide Web Consortium) provides P3P (Platform for Privacy Preference), Oasis Group provides XACML (eXtensible Access Control Markup Language), and IBM provides EPAL (Enterprise Privacy Authentication Language).

At the present time, a phishing preventing technology is suggested in order to prevent phishing, which illegally acquires personal information by making a false homepage of a famous homepage and sending an email to a plurality of unspecified email users to direct the users to access the disguised homepage.

### DISCLOSURE OF INVENTION

### Technical Problem

The present invention has been made to solve the above-described problems, and it is an object of the present invention to provide a personal information management apparatus and method that is capable of preventing personal information that a user provides to a website when joining the website from being illegally used by other websites.

### Technical Solution

In order to achieve the above-described object, a personal information management apparatus according to a preferred embodiment of the present invention includes a personal information database that stores personal information of users including shared secret information; and an access module unit that receives a personal information request message, which includes a hash value hashed by shared secret information and a time value and the time value used at the time of generating the hash value, from an information utilization server, reads out personal information corresponding to the received personal information request message from the personal information database according to whether the received personal information request message is authorized or not, and transmits the personal information to the information utilization server.

The access module unit may use a user identifier included in the personal information request message to read out shared secret information of a corresponding user from the personal information database, and, when a hash value, which is generated by converting a value including the read shared secret information and the time value included in the personal information request message using a hash function, is the same as the hash value included in the personal information request message, determine that the personal information request message is authorized.

The access module unit may compare the time value, which is included in the personal information request message and used at the time of generating the hash value, and a current time when the personal information request message is received, and, when a time difference between the time value and the current time exceeds a predetermined time, determine that the personal information request message is not authorized.

A personal information management apparatus according to another embodiment of the present invention includes a link information storage unit that stores link information used to link with an information providing server; and an access module unit that receives a personal information utilization permission message, which includes a hash value hashed by shared secret information of a corresponding user and a time value and the time value used at the time of generating the hash value, from a user terminal, links with the information providing server on the basis of the link information to transmit a personal information request message for the corresponding user including the hash value and the time value to the information providing server, and receives personal information of the corresponding user transmitted from the information providing server on the basis of the personal information request message.

A personal information management method according to an embodiment of the present invention includes a personal information storing step of allowing an information providing server to store personal information of users including shared secret information in a database; a personal information utilization permission request message transmitting step of allowing an information utilization server to transmit a personal information utilization permission request message to a user terminal; a personal information request message transmitting step of allowing the information utilization server to receive a personal information utilization permission message, which includes a hash value of shared secret information of a corresponding user and a time value and the time value used at the time of generating the hash value, from the user terminal, and to link with the information providing server to transmit a personal information request message for the corresponding user including the hash value and the time value to the information providing server; a request message determining step of allowing the information providing server to determine whether the received personal information request message is authorized or not; and a personal information transmitting step of allowing the information providing server to transmit personal information of the user corresponding to the personal information request message to the information utilization server, when it is determined that the personal information request message is authorized in the request message determining step.

The request message determining step may include a step of reading out the shared secret information of the corresponding user from the database using a user identifier included in the personal information request message; a step of comparing a hash value, which is generated by converting a value including the read shared secret information and the time value included in the personal information request message using a hash function, and the hash value included in the personal information request message; and a step of determining that the personal information request message is authorized, when it is determined that the two hash values are the same as a compared result.

The request message determining step may include a step of comparing the time value, which is included in the personal information request message and used at the time of generating the hash value, and a current time when the personal information request message is received; and a step of determining that the personal information request message is not authorized, when it is determined that a time difference between the time value and the current time exceeds a predetermined time as a compared result.

A personal information management method according to another embodiment of the present invention includes a storing step of allowing a registration module unit to store personal information of users including shared secret information in a database; a determining step of allowing an access module unit to determine whether a personal information request message, which includes a hash value hashed by shared secret information and a time value and the time value used at the time of generating the hash value and is transmitted from an information utilization server, is authorized or not; and a transmitting step of allowing the access module unit to read out personal information corresponding to the personal information request message from the database and transmit the personal information to the information utilization sever, when it is determined that the personal information request message is authorized in the determining step.

The determining step may include a step of reading out shared secret information of a corresponding user from the database using a user identifier included in the personal information request message; a step of comparing a hash value, which is generated by converting a value including the read shared secret information and the time value included in the personal information request message using a hash function, and the hash value included in the personal information request message; and a step of determining that the personal information request message is authorized, when it is determined that the two hash values are the same as a compared result.

The determining step may include a step of comparing the time value, which is included in the personal information request message and used at the time of generating the hash value, and a current time when the personal information request message is received; and a step of determining that the personal information request message is not authorized, when it is determined that a time difference between the time value and the current time exceeds a predetermined time as a compared result.

A personal information management method according to still another embodiment of the present invention includes a storing step of allowing a registration module unit to store link information used to link with an information providing server in a storage unit; a message transmitting step of allowing an access module unit to receive a personal information utilization permission message, which includes a hash value hashed by shared secret information of a corresponding user and a time value and the time value used at the time of generating the hash value, from a user terminal, and to link with the information providing server on the basis of the link information of the storage unit to transmit a personal information request message for the corresponding user including the hash value and the time value to the information providing server; and a receiving step of allowing the access module unit to receive personal information of the corresponding user transmitted from the information providing server on the basis of the personal information request message.

### ADVANTAGEOUS EFFECTS

According to the present invention that has the above-described structure, after storing personal information of a user in a reliable website, when the user joins a general website, the user provides link information instead of personal information of the corresponding user, such that the general website can only use personal information by permission of the corresponding user, thereby resolving a problem that occurs when personal information is illegally used.

Therefore, the present invention minimizes exposure of personal information, which prevents the personal information of the user from being illegally used by a general website.

### BRIEF DESCRIPTION OF THE DRAWINGS

FIG. 1 is a diagram illustrating a system that adopts a personal information management apparatus according to an embodiment of the present invention.

FIG. 2 is a diagram illustrating information that is stored in a link information storage unit of an information utilization server and information that is stored in a personal information database of an information providing server, which are shown in FIG. 1.

FIG. 3 is a flowchart illustrating the flow of a process when an information providing server shown in FIG. 1 needs personal information of a user.

FIG. 4 is a flowchart illustrating the flow of a process that is executed when an information providing server shown in FIG. 1 receives a personal information request message.

FIG. 5 is a flowchart specifically illustrating a process in which an information providing server determines whether a personal information request message is authorized or not.

### BEST MODE FOR CARRYING OUT THE INVENTION

In the present invention, when joining a general website, a user does not register personal information, but stores information (link information) that can be used to link with another website (reliable website) where the personal information is stored. When the general website requires the personal information of the user, the general website links with another website with a user's permission and accesses contents of the personal information. That is, the present invention is to minimize the exposure of personal information of the user and prevent user information from being illegally used by the general website.

Hereinafter, a personal information management apparatus and method according to an embodiment of the present invention will be described with reference to the accompanying drawings.

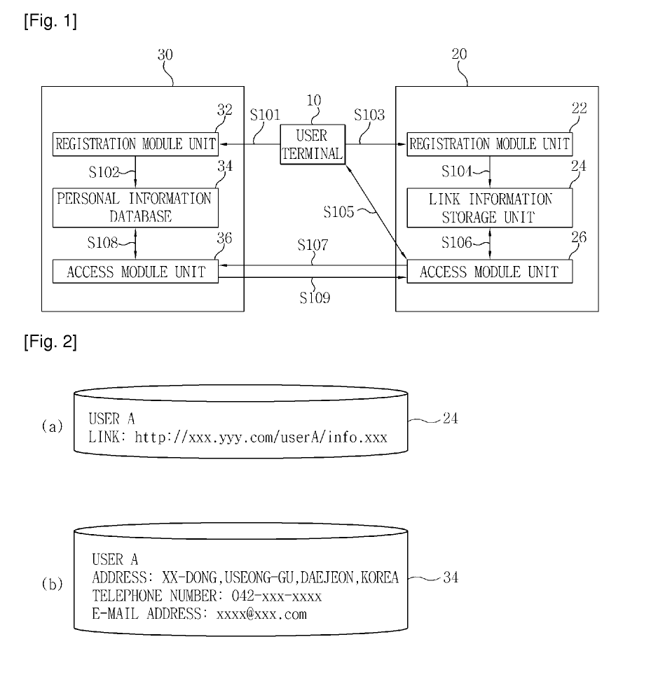

FIG. 1 is a diagram illustrating a system that adopts a personal information management apparatus according to an embodiment of the present invention.

Specifically, FIG. 1 shows a relationship between a user terminal 10, an information utilization server 20, and an information providing server 30 that can systemically communicate with each other through a network (for example, Internet (not shown)).

The user terminal 10 is used to use websites on a network, such as the Internet. The user terminal 10 is a communication device, such as a computer, a mobile communication terminal, a PDA, and a TV, which uses a Web browser, such as Internet Explorer supported by Microsoft Corporation and Navigator supported by Netscape Communications, Inc. The user terminal 10 stores a program that can execute a hashing algorithm.

The information utilization server 20 links with a reliable website that is operated by the information providing server 30 with the user's permission and receives personal information of the corresponding user. In this embodiment, the information utilization server 20 may be a server that operates a general website.

The information utilization server 20 includes a registration module unit 22, a link information storage unit 24, and an access module unit 26. The registration module unit 22 receives link information (that is, including an address used to link with the reliable website that is operated by the information providing server 30) from the user terminal 10 and stores the link information in the link information storage unit 24. The access module unit 26 requests the user terminal 10 for permission to utilize personal information. If the access module unit 26 receives a permission message from the user terminal 10, the access module unit 26 links with the reliable website that is operated by the information providing server 30 on the basis of the link information stored in the link information storage unit 24. The access module unit 26 links with the reliable website and transmits a message to request personal information of a user to the information providing server 30. The access module unit 26 receives personal information of the corresponding user from the information providing server 30.

The information providing server 30 operates the reliable website that stores personal information of the user.

The information providing server 30 includes a registration module unit 32, a personal information database 34, and an access module unit 36. The registration module unit 32 stores personal information (for example, a user ID, a password, a name, an address, a social security number, and an e-mail address) input from the user terminal 10 in the personal information database 34. Personal information that is stored in the personal information database 34 includes shared secret information. The shared secret information is information that is generated when the user joins the reliable website of the information providing server 30. The shared secret information is composed of a simple character string, such as a password of the user. The shared secret information is safely stored in the personal information database 34. When receiving a personal information request message from the information utilization server 26, the access module unit 36 determines whether the personal information request message is authorized or not, and transmits personal information of the user to the information utilization server 20.

In FIG. 1, one user terminal 10 and one information utilization server 20 are shown. However, it should be understood that a plurality of user terminals and information utilization servers actually exist. In addition, a plurality of information providing servers 30 may exist. However, since only one information providing server 30 is needed to describe the present invention, the plurality of information providing servers 30 will not be presently described.

The process operation of the system that is implemented as shown in FIG. 1 will be schematically described below.

First, the user uses the user terminal 10 to input personal information to the reliable website of the information providing server 30 so as to join the reliable website (S101). The registration module unit 32 of the information providing server 30 registers the received personal information of the user in the personal information database 34 (S102). At this time, since the user and the reliable website share shared secret information with each other in advance, actually, the personal information of the user and the shared secret information are registered in the personal information database 34.

Then, when the user joins the general website of the information utilization server 20, the general website requests the user to input the personal information. At this time, the user does not input actual contents of the personal information of the user but inputs link information that can be used to link with the reliable website that is operated by the information providing server 30 (S103). The registration module unit 22 of the information utilization server 20 stores the received link information in the link information storage unit 24 (S104).

When the general website requires personal information of the user for an arbitrary object, the access module unit 26 of the information utilization server 20 transmits a message, which requests permission to utilize the personal information, to the user terminal 10, and the user responds to the corresponding message using the user terminal 10 (S105). At this time, the user inserts the shared secret information, which is shared by the reliable website and the user, into a response message. That is, primarily, since the general website cannot perform the following operation without permission to utilize the personal information, the general website cannot obtain personal information of the user. Even if the general website reads the link information, the general website still cannot obtain the shared secret information. Therefore, the general website cannot obtain personal information of the user.

Then, the access module unit 26 of the information utilization server 20 reads out the link information that is stored in the link information storage unit 24 (S106). The access module unit 26 links with the reliable website of the information providing server 30 on the basis of the read link information and requests personal information of the user (S107). At this time, a personal information request message includes a user identifier, necessary personal information items, and shared secret information.

The access module unit 36 of the information providing server 30 that has received the personal information request message from the access module unit 26 confirms access permission for personal information of the user on the basis of the user identifier and the shared secret information included in the corresponding message. As a confirmed result, when it is determined that access is permitted, the access module unit 36 reads out the personal information of the corresponding user from the personal information database 34 (S108). The access module unit 36 transmits the read personal information of the corresponding user to the general website (in detail, the access module unit 26 shown in FIG. 1) that has transmitted the personal information request message (S109).

As such, according to the present invention, even if utilization of the personal information is permitted, when the access is not permitted in an access permission confirmation process for personal information of the user on the basis of the shared secret information that is secondarily performed, it is not possible to obtain personal information of the corresponding user.

FIG. 2 is a diagram illustrating information that is stored in a link information storage unit 24 of an information utilization server 20 and information that is stored in a personal information database 34 of an information providing server 30, which are shown in FIG. 1.

As exemplified in (a) of FIG. 2, the link information storage unit 24 stores link information (user identifier (ID or name)), and a link address (for example, http://xxx.yyy.com/userA/info.xxx)) that can be used to link with the reliable website where the actual personal information of the user is stored.

As shown in (b) of FIG. 2, the personal information database 34 stores the actual personal information of the user (a user identifier (ID or name), an address, a telephone number, an e-mail address, and a social security number). Of course, the personal information database 34 stores shared secret information for each user, but it is not shown in FIG. 2.

Accordingly, when the information utilization server 20 needs personal information of the user, the information utilization server 20 uses the link information stored in the link information storage unit 24 and requests the information providing server 30 of personal information of the user.

In (a) and (b) of FIG. 2, link information and personal information for only one user are stored in the link information storage unit 24 and the personal information database 34. However, in actual, the link information storage unit 24 stores respective link information for a plurality of users, and the personal information database 34 stores respective personal information for the plurality of users.

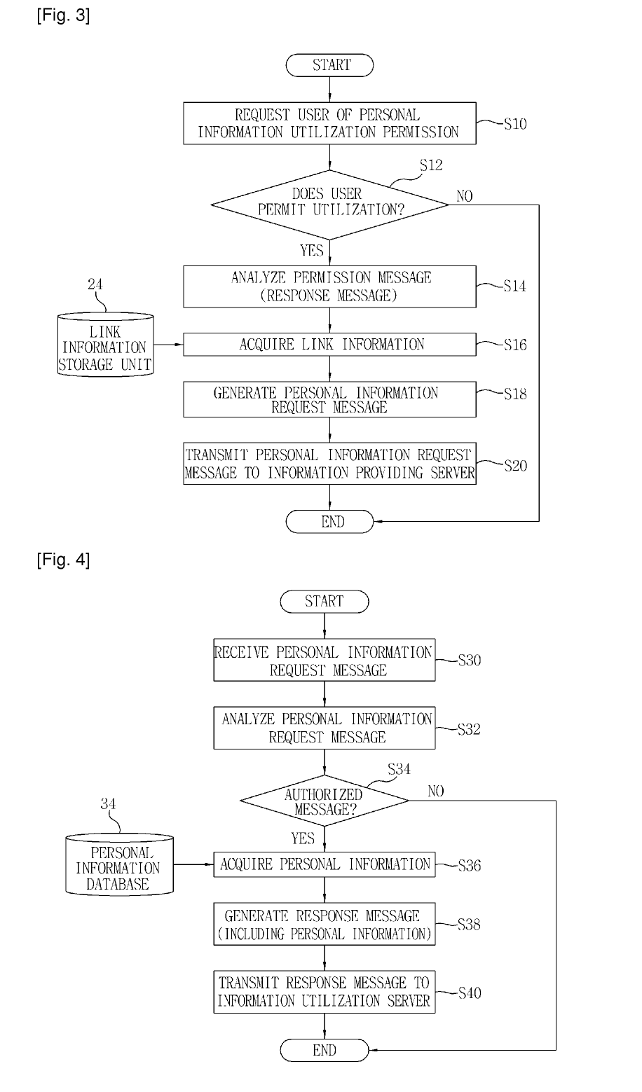

FIG. 3 is a flowchart illustrating the flow of a process when an information providing server 20 shown in FIG. 1 needs personal information of a user.

When the personal information of the user is needed, the access module unit 26 transmits a message requesting permission to utilize personal information (that is, personal information utilization permission request message) to the user terminal 10 (S10). The personal information utilization permission request message includes information on a utilization relationship between information and objects.

If the user confirms the personal information utilization permission request message received from the user terminal 10 and determines permission to utilize the personal information (“Yes” in S12), the user uses the user terminal 10 to generate a permission message (that is, response message) that includes shared secret information shared between the user and the reliable website, and transmits the permission message to the access module unit 26. In this case, the shared secret information is not included in the permission message without a security checking process because the shared secret information should not be known to the general websites. The user side converts a value including the shared secret information and a current time value into a hash value using a hash function to generate the hash value. For example, if the shared secret information is “A” and the current time value is “B”, a value that includes the shared secret value and the current time value becomes “A|B”. That is, the value including the shared secret information and the current time value becomes a value of A and B. The generation of the hash value means that the value (A|B) is converted into the hash value (X=H(A|B)) using the hash function. It is preferably understood that the current time value means a value of the time when the hash value is generated or a value of the time right before generating a permission message (that is, response message).

That is, the permission message that is transmitted from the user terminal 10 to the information utilization server 20 includes the hash value instead of the shared secret information and the time value (that is, it may become a current time value) used to generate the hash value. The reason why the time value (that is, it may become the current time value) is included in addition to the hash value is as follows. For example, if the time value does not exist, after the general website transmits an information utilization permission request message to the user and receives a response message indicating permission, the general website can reuse the information utilization permission request message. Therefore, the time value is further included in order to prevent the message permitted by the user from be reused.

The access module unit 26 analyzes the permission message received from the user terminal 10 and extracts the shared secret information (more accurately, the hash value and the time value included in the permission message) (S14).

Then, the access module unit 26 reads out the link information from the link information storage unit 24 and recognizes the destination of the personal information request message (S16).

The access module unit 26 generates a personal information request message that includes a user identifier (for example, ID), necessary personal information items, and shared secret information (more accurately, the hash value and the time value) (S18). The access module unit 26 may change the operation sequence of Steps S16 and S18 described above and perform Steps according to the changed operation sequence.

Then, the access module unit 26 transmits the generated personal information request message to the information providing server 30 (S20).

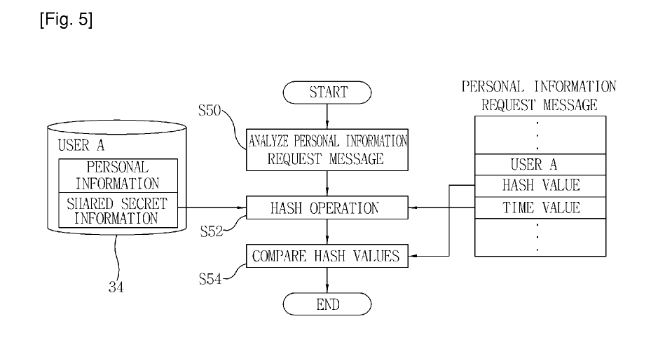

FIG. 4 is a flowchart illustrating the flow of a process that is executed when an information providing server 30 shown in FIG. 1 receives a personal information request message.

The access module unit 36 that is included in the information providing server 30 receives the personal information request message from the information utilization server 20 (S30).

The access module unit 36 extracts a user identifier (for example, ID) and shared secret information from the received personal information request message and analyzes whether the received personal information request message is authorized or not (S32). The detailed process of analyzing whether the received personal information request message is authorized or not will be described below with reference to FIG. 5.

As an analyzed result, when it is determined that the received personal information request message is authorized (“Yes” in S34), the access module unit 36 reads out the personal information of the corresponding user from the personal information database 34 (S36).

The access module unit 36 generates a response message that includes the read personal information of the corresponding user (S38), and transmits the response message to the information utilization server 20 (S40).

FIG. 5 is a flowchart specifically illustrating a process in which an information providing server 30 determines whether a personal information request message is authorized or not.

When the access module unit 36 included in the information providing server 30 analyzes the personal information request message (S50) and confirms whether the personal information request message is authorized or not, the access module unit 36 uses the hash value and the time value used at the time of generating the hash value that are included in the personal information request message.

That is, the access module unit 36 uses the user identifier (for example, ID) included in the personal information request message to read out the shared secret information of the corresponding user stored in the personal information database 34. The access module unit 36 uses the hash function to convert the value including the read shared secret information and the time value included in the personal information request message (that is, time value used at the time of generating the hash value) into a hash value to generate the hash value (S52). The hash value generating process that is performed by the access module unit 36 is the same as the hash value generating process in the description that is given with reference to FIG. 3. The access module unit 36 compares the generated hash value and the hash value included in the personal information request message to determine whether the two hash values are the same (S54). When the two hash values are the same, the access module unit 36 determines that the received personal information request message is authorized. When the two hash values are not the same, the access module unit 36 determines that the received personal information request message is not authorized.

Meanwhile, after a large amount of time passes in a state where the information utilization server 20 knows the hash value and the time value used at the time of generating the hash value, if the information utilization server 20 transmits the personal information request message to the information providing server 30 without permission of the user, the information providing server 30 provides personal information of the corresponding user to the information utilization server 20. In order to prevent this, the access module unit 36 compares the time value used at the time of generating the hash value included in the personal information request message and the current time (that is, current time when the personal information request message is received). As a compared result, when it is determined that the time difference between the time value and the current time exceeds the predetermined time (for example, approximately one hour), the access module unit 36 may determine that the personal information request message is not authorized. In this way, it is possible to further prevent the personal information from being illegally used. Here, one hour is only exemplary, and time shorter or longer than one hour may be used.

The present invention is not limited to the above-described embodiment, and it will be apparent to those skilled in the art that various changes and modifications can be made without departing from the spirit and scope of the present invention, and the changes and the modifications are included in the following appended claims.

1. A personal information management apparatus comprising:
a personal information database that stores personal information of users including shared secret information; and
an access module unit that receives a personal information request message, which includes a hash value hashed by the shared secret information and a time value and the time value used at the time of generating the hash value, from an information utilization server, reads out personal information corresponding to the received personal information request message from the personal information database according to whether the received personal information request message is authorized or not, and transmits the personal information to the information utilization server.

2. The personal information management apparatus of claim 1,
wherein the access module unit uses a user identifier included in the personal information request message to read out shared secret information of a corresponding user from the personal information database, and, when a hash value, which is generated by converting a value including the read shared secret information and the time value included in the personal information request message using a hash function, is the same as the hash value included in the personal information request message, determines that the personal information request message is authorized.

3. The personal information management apparatus of claim 1,
wherein the access module unit compares the time value, which is included in the personal information request message and used at the time of generating the hash value, and a current time when the personal information request message is received, and, when a time difference between the time value and the current time exceeds a predetermined time, determines that the personal information request message is not authorized.

4. A personal information management apparatus comprising:
a link information storage unit that stores link information used to link with an information providing server; and
an access module unit that receives a personal information utilization permission message, which includes a hash value hashed by shared secret information of a corresponding user and a time value and the time value used at the time of generating the hash value, from a user terminal, links with the information providing server on the basis of the link information to transmit a personal information request message for the corresponding user including the hash value and the time value to the information providing server, and receives personal information of the corresponding user transmitted from the information providing server on the basis of the personal information request message.

5. A personal information management method comprising:
a personal information storing step of allowing an information providing server to store personal information of users including shared secret information in a database;
a personal information utilization permission request message transmitting step of allowing an information utilization server to transmit a personal information utilization permission request message to a user terminal;
a personal information request message transmitting step of allowing the information utilization server to receive a personal information utilization permission message, which includes a hash value of shared secret information of a corresponding user and a time value and the time value used at the time of generating the hash value, from the user terminal, and to link with the information providing server to transmit a personal information request message for the corresponding user including the hash value and the time value to the information providing server;
a request message determining step of allowing the information providing server to determine whether the received personal information request message is authorized or not; and
a personal information transmitting step of allowing the information providing server to transmit personal information of the user corresponding to the personal information request message to the information utilization server, when it is determined that the personal information request message is authorized in the request message determining step.

6. The personal information management method of claim 5,
wherein the request message determining step includes:
a step of reading out the shared secret information of the corresponding user from the database using a user identifier included in the personal information request message;
a step of comparing a hash value, which is generated by converting a value including the read shared secret information and the time value included in the personal information request message using a hash function, and the hash value included in the personal information request message; and
a step of determining that the personal information request message is authorized, when it is determined that the two hash values are the same as a compared result.

7. The personal information management method of claim 5,
wherein the request message determining step includes:
a step of comparing the time value, which is included in the personal information request message and used at the time of generating the hash value, and a current time when the personal information request message is received; and
a step of determining that the personal information request message is not authorized, when it is determined that a time difference between the time value and the current time exceeds a predetermined time as a compared result.

8. A personal information management method comprising:
a storing step of allowing a registration module unit to store personal information of users including shared secret information in a database;
a determining step of allowing an access module unit to determine whether a personal information request message, which includes a hash value hashed by shared secret information and a time value and the time value used at the time of generating the hash value and is transmitted from an information utilization server, is authorized or not; and
a transmitting step of allowing the access module unit to read out personal information corresponding to the personal information request message from the database and transmit the personal information to the information utilization sever, when it is determined that the personal information request message is authorized in the determining step.

9. The personal information management method of claim 8,
wherein the determining step includes:
a step of reading out shared secret information of a corresponding user from the database using a user identifier included in the personal information request message;
a step of comparing a hash value, which is generated by converting a value including the read shared secret information and the time value included in the personal information request message using a hash function, and the hash value included in the personal information request message; and
a step of determining that the personal information request message is authorized, when it is determined that the two hash values are the same as a compared result.

10. The personal information management method of claim 8,
wherein the determining step includes:
a step of comparing the time value, which is included in the personal information request message and used at the time of generating the hash value, and a current time when the personal information request message is received; and
a step of determining that the personal information request message is not authorized, when it is determined that a time difference between the time value and the current time exceeds a predetermined time as a compared result.

11. A personal information management method comprising:
a storing step of allowing a registration module unit to store link information used to link with an information providing server in a storage unit;
a message transmitting step of allowing an access module unit to receive a personal information utilization permission message, which includes a hash value hashed by shared secret information of a corresponding user and a time value and the time value used at the time of generating the hash value, from a user terminal, and to link with the information providing server on the basis of the link information of the storage unit to transmit a personal information request message for the corresponding user including the hash value and the time value to the information providing server; and
a receiving step of allowing the access module unit to receive personal information of the corresponding user transmitted from the information providing server on the basis of the personal information request message.
